(19) United States
(12) Patent Application Publication
(10) Pub. No.: US 2023/0280918 A1
(43) Pub. Date: Sep. 7, 2023

(54) SERVER AND COMPUTER

(71) Applicant: Kioxia Corporation, Tokyo (JP)

(72) Inventor: Yasuhiro TSURUNAGA, Kamakura Kanagawa (JP)

(21) Appl. No.: 17/895,971

(22) Filed: Aug. 25, 2022

(30) Foreign Application Priority Data
Mar. 4, 2022 (JP) 2022-033900

(51) Int. Cl. G06F 3/06

(52) U.S. Cl. CPC G06F 3/0634; G06F 3/0659; G06F 3/067; G06F 3/0604

(57) ABSTRACT

A server includes: a managing unit configured to manage a first access data with respect to a first memory device and a second access data with respect to a second memory device; a condition deciding unit configured to decide a recommended operation mode of the first memory device based on information including the second access data; and a sending unit configured to send the recommended operation mode decided by the condition deciding unit to an apparatus configured to control the first memory device.

### CROSS REFERENCE TO RELATED APPLICATIONS

This application claims the benefit of priority to Japanese Patent Application No. 2022-033900, filed on Mar. 4, 2022, the entire contents of which are incorporated herein by reference.

### FIELD

The present embodiment relates to a server and a computer. Specifically, the present embodiment relates to a server capable of proposing an operation mode of a memory device provided in a computer, and a computer that communicates with the server and requests an operation for the memory device.

### BACKGROUND

A memory device included in a computer is designed in versatile operation modes to withstand a variety of uses when the memory device is shipped to the market. Therefore, the operation mode of the memory device may not be set to a mode suitable for computer usage in the market.

### BRIEF DESCRIPTION OF DRAWINGS

FIG. 1 is a diagram showing an outline of a memory operation management system according to an embodiment.

FIG. 2 is a block diagram showing an outline of a memory operation management system according to an embodiment.

FIG. 3 is a schematic view showing a functional configuration of a server according to an embodiment.

FIG. 4 is a schematic view showing a functional configuration of a host computer according to an embodiment.

FIG. 5 is a sequence diagram showing an operation mode recommendation method in a memory operation management system according to an embodiment.

FIG. 6 is a flowchart showing an operation mode recommendation method in a memory operation management system according to an embodiment.

FIG. 7 is a diagram showing an example of a host access diagnostic database according to an embodiment.

FIG. 8 is a flowchart showing an operation mode recommendation method in a memory operation management system according to an embodiment.

FIG. 9 is a diagram showing a specific example of an operation mode recommendation method according to an embodiment.

FIG. 10 is a sequence diagram showing an operation mode recommendation operation in a memory operation management system according to an embodiment.

### DESCRIPTION OF EMBODIMENTS

It is possible to propose an operation mode of a memory device according to the usage of the memory device by a server and a computer according to the present embodiment.

A server according to an embodiment includes: a managing unit configured to manage a first access data with respect to a first memory device and a second access data with respect to a second memory device; a condition deciding unit configured to decide a recommended operation mode of the first memory device based on information including the second access data; and a sending unit configured to send the recommended operation mode decided by the condition deciding unit to an apparatus configured to control the first memory device.

Hereinafter, the server and the computer according to the embodiment will be described in detail with reference to the drawings. In the following description, components having substantially the same functions and configurations are denoted by the same symbols, and duplicate descriptions are given only when necessary. Each of the embodiments described below exemplifies a device and a method for embodying a technical idea of the present embodiment. The technical idea of the embodiment is not limited to the material, shape, structure, arrangement, and the like of components described later. Various modifications may be applied to the technical idea of the embodiment in addition to the scope of the claims.

The following embodiments may be combined with each other as long as there is no technical contradiction.

### 1. First Embodiment

[1-1. Overall Configuration of Memory Management System 10]

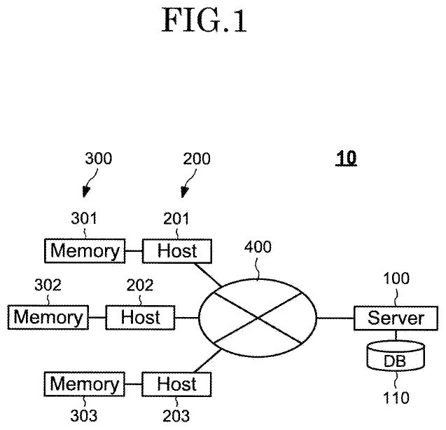

A memory operation managing system 10 according to the first embodiment will be described with reference to FIG. 1. FIG. 1 is a diagram showing an outline of a memory operation management system according to an embodiment. The memory operation management system 10 includes a server 100 (Server), a host computer 200 (Host), and a memory device 300 (Memory). The host computer 200 can communicate with the server 100 via a network 400. The memory device 300 is provided in the host computer 200.

A plurality of host computers 200 and memory devices 300 are provided with respect to one server 100. In the case where the plurality of host computers 200 is expressed separately, they are referred to as host computers 201, 202, and 203. Similarly, in the case where the plurality of memory devices 300 is expressed separately, they are referred to as memory devices 301, 302, and 303. The memory devices 301, 302, and 303 are provided in the host computers 201, 202, and 203, respectively. The memory devices 301, 302, and 303 execute write operations and read operations in response to requests from the host computers 201, 202, and 203, respectively.

In the following explanation, the host computer 200 includes, for example, a mobile communication terminal such as a smartphone or a tablet terminal, a stationary communication terminal such as a desktop personal computer, and a computer mounted on a vehicle, a home appliance, or the like.

The server 100 receives access data for the plurality of memory devices 300 from the plurality of host computers 200 via the network 400. Based on the access data, the server 100 determines the operation mode of the memory device 300 suitable for the plurality of host computers 200. Details of the access data will be described later.

The server 100 is connected to a database 110 (DB). The database 110 manages the access data received from the plurality of host computers 200. Furthermore, the database 110 manages a memory operation mode table including a plurality of operation modes determined based on the access data. Although a configuration in which the database 110 is directly connected to the server 100 is exemplified in FIG. 1, the present disclosure is not limited to this configuration. For example, the database 110 may be directly connected to the network 400 and data may be sent and received between the server 100 and the database 110 via the network 400.

The network 400 is an Internet provided by a general World Wide Web (WWW) service, a WAN (Wide Area Network), or a LAN (Local Area Network) such as an internal LAN. As described above, the host computer 200 communicates with the server 100 via the network 400.

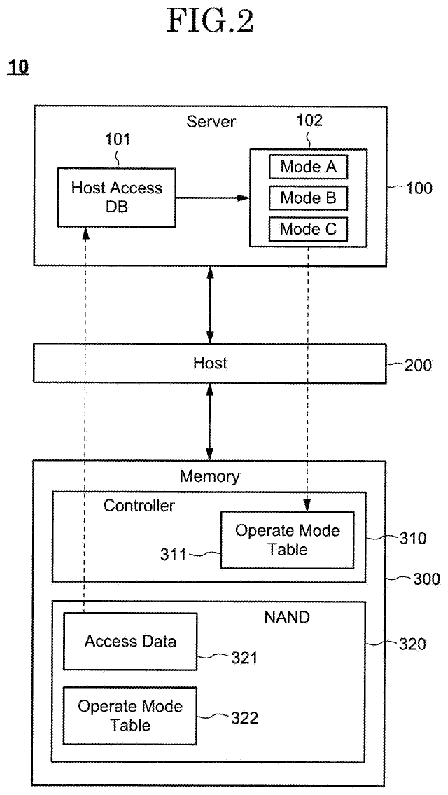

FIG. 2 is a block diagram showing an outline of a memory operation management system according to an embodiment. As shown in FIG. 2, the memory device 300 includes a memory controller 310 (Controller) and a non-volatile memory 320 (NAND). The memory controller 310 receives a write request and a read request from the host computer 200 by communicating with the host computer 200. The write request includes a write command, a write address, and write data. The read request includes a read command and a read address.

The non-volatile memory 320 includes a memory cell array including a plurality of memory cells. The non-volatile memory 320 may be a NAND flash memory with a two-dimensional structure or a NAND flash memory with a three-dimensional structure. The non-volatile memory 320 includes a plurality of word lines and gate lines. The plurality of memory cells are connected to the same word line or the same gate line. That is, the plurality of memory cells arranged along the word line share one word line. Similarly, the plurality of memory cells arranged along the gate line share one gate line.

The memory controller 310 includes an operation mode table 311. The non-volatile memory 320 stores access data 321 and an operation mode table 322 based on the information included in the write request and the read request. The memory controller 310 reads the operation mode table 311 suitable for the current setting from a plurality of operation mode tables 322 stored in the non-volatile memory 320, and temporarily stores the read operation mode table 311 in a RAM (Random Access Memory) provided in the memory controller 310. In addition to the operation mode table, various kinds of management information may be stored in the non-volatile memory 320.

The operation mode table 311 includes, for example, a parameter for executing the write operation or read operation under a plurality of conditions. For example, the parameter includes a write voltage supplied to the memory cell in the write operation, a read voltage supplied to the memory cell in the read operation, and an address of the memory cell for which the write operation and the read operation are executed. In the operation mode table 311, the parameter is managed in association with the operation mode of the memory device 300.

The access data 321 includes the number of write operations (including the number of erase operations), the number of read operations, the write address, the read address, a chunk size, a total host write amount, operation temperature information, and a shift table. The operation mode table 311 includes patrol information.

The chunk size refers to a unit size accessed by the host computer 200, regardless of the configuration of the non-volatile memory 320. The total host write amount refers to a total amount of data that the host computer 200 has requested to be written.

For example, the patrol information indicates a read patrol frequency. When time elapses after data is written to the memory cell, a phenomenon called data retention may occur. The data retention is a phenomenon in which a threshold distribution shifts due to interference between memory cells. The read patrol frequency is a frequency at which the memory controller 310 executes the read operation from the non-volatile memory 320 to check the state of the memory cell, considering a possibility of the data retention due to the memory cell being left unattended for a long time. In this case, “the memory cell being left unattended” means, for example, that there is no access to the memory cell, such that the read operation by the memory controller 310 is not executed.

The shift table is a table in which a plurality of read conditions, which are determined by assuming that the threshold value of the memory cell changes (e.g., a change in the amount of charge held by the memory cell) due to a change in the state of the memory cell, is set. The information relating to the shift table included in the access data 321 may include, for example, the number of times that the read operation is successful or failed among a plurality of combinations of the read voltage managed in the shift table.

The above information exemplified as the access data 321 is merely an example of the access data 321. The access data 321 may include information other than the above information.

In the present embodiment, the memory controller 310 reads the appropriate operation mode table 311 from the plurality of operation mode tables 322 stored in the non-volatile memory 320 based on the operation mode specified by the server 100, and executes the write operation or read operation using the operation mode table 311.

The server 100 includes a host access diagnostic database 101 (Host Access DB) and a memory operation mode table 102. The access data 321 stored in the non-volatile memory 320 is sent from the memory controller 310 to the host computer 200 and sent from the host computer 200 to the server 100 according to a request from the host computer 200. The host access diagnostic database 101 manages the access data 321 received from the plurality of host computers 200.

In the present embodiment, the server 100 is provided for each type (category) of host computer 200 or memory device 300. That is, in the case where the present embodiment is applied to the plurality of types (categories) of host computer 200 or memory device 300, a plurality of servers 100 is provided according to the type of host computer 200 or memory device 300. In this case, the server 100 corresponding to the host computer 200 or the memory device 300 is selected based on host-specific information identifying the host computer 200 or memory-specific information identifying the memory device 300.

However, the present embodiment is not limited to the above configuration. For example, the host access diagnostic database 101 may manage the access data 321 in association with the memory-specific information. The memory-specific information is information for identifying the memory device 300 that stores the access data 321. Alternatively, the host access diagnostic database 101 may manage the access data 321 in association with the host-specific information. The host-specific information is information for identifying the host computer 200 that sent the access data 321 to the server 100. The host access diagnostic database 101 may manage the type of the memory device 300 or the type of the host computer 200 in association with the access data 321. The type of the memory device 300 is the type of the memory device when the memory device is classified based on its application, function, and performance (e.g., grades of the memory device). The type of the host computer 200 is the type of the computer when the computer is classified based on its application, function, and performance (e.g., classification of communication terminals, vehicles, home appliances, etc.).

The memory operation mode table 102 manages the plurality of operation modes (e.g., “operation mode A (Mode A)”, “operation mode B (Mode B)”, and “operation mode C (Mode C)”). The memory operation mode table 102 may manage the plurality of operation modes for each of the memory-specific information for identifying the memory device 300 or for each of the host-specific information for identifying the host computer 200, and may manage the plurality of operation modes for each of the above types of the memory device 300 or each of the above types of the host computer 200. Although described in detailed later, the server 100 decides the operation mode suitable for the memory device 300 or the host computer 200 from the memory operation mode table 102 and sends the operation mode to the host computer 200 when the information managed by the host access diagnostic database 101 satisfies a predetermined condition for a particular memory device 300 or host computer 200.

[1-2. Functional Configuration of Server 100]

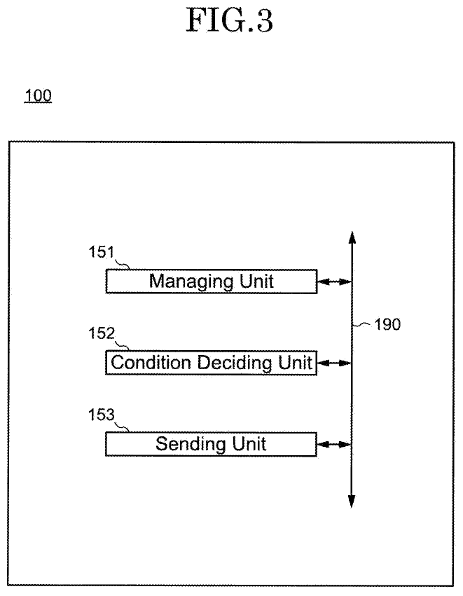

FIG. 3 is a schematic view showing a functional configuration of a server according to an embodiment. As shown in FIG. 3, the server 100 includes a managing unit 151, a condition deciding unit 152, and a sending unit 153. The managing unit 151, the condition deciding unit 152, and the sending unit 153 are connected to be communicable with each other via a communication bus 190.

The managing unit 151 stores and manages the access data 321 for the plurality of memory devices 300 in the host access diagnostic database 101. For example, the managing unit 151 manages access data 321-1 (first access data) for the memory device 301 (first memory device) received from the host computer 201 (first host computer) shown in FIG. 1 and access data 321-2 (second access data) for the memory device 302 (second memory device) received from the host computer 202 (second host computer) by the server 100.

The managing unit 151 may manage the first access data 321-1 in association with at least one of the memory-specific information (first memory-specific information) for identifying the first memory device 301 and the host-specific information for identifying the first host computer 201. Similarly, the managing unit 151 may manage the second access data 321-2 in association with at least one of the memory-specific information for identifying the second memory device 302 (second memory-specific information) and the host-specific information for identifying the second host computer 202. In the case where the server 100 includes a plurality of host access diagnostic databases 101, the managing unit 151 may manage the access data 321 in a different host access diagnostic database 101 for each of the memory-specific information for identifying the memory device 300 or the host-specific information for identifying the host computer 200. Since the managing unit 151 manages the host-specific information, for example, when abnormal data is detected in the access data or the like, tracing for determining the cause of the abnormal data is possible.

In addition to the above, the managing unit 151 manages the plurality of operation modes (e.g., “operation mode A (Mode A)”, “operation mode B (Mode B)”, and “operation mode C (Mode C)”) of the memory device 300. These operation modes may be referred to as “candidate operation mode.”

The condition deciding unit 152 decides an appropriate operation mode of the specific memory device 300 based on information including the access data 321 of another memory device 300 different from the specific memory device 300. For example, the condition deciding unit 152 selects one operation mode (recommended operation mode) from the plurality of candidate operation modes based on information including the second access data 321-2 for the second memory device 302 to decide a recommended operation mode suitable for the first memory device 301. In other words, the condition deciding unit 152 decides the recommended operation mode of its own memory device 300 based on the operation mode of the other memory device 300.

Of course, the condition deciding unit 152 may use the access data of the specific memory device 300 (its own memory device 300) when an appropriate recommended operation mode is decided for the specific memory device 300. That is, the condition deciding unit 152 may decide the recommended operation mode of the first memory device 301 based on the information including both the first access data 321-1 for the first memory device 301 and the second access data 321-2 for the second memory device 302.

For example, after the first memory device 301 has been put on the market in the state of being incorporated in the first host computer 201, the condition deciding unit 152 can change the operation mode of the first memory device 301 based on the access data of the other second memory device 302 that has already been put on the market and actually used. Specifically, the condition deciding unit 152 decides whether the operation mode needs to be changed according to an inquiry from the first host computer 201. As a result, if the operation mode needs to be changed, the condition deciding unit 152 decides the recommended operation mode of the memory device 300 as described above.

When the access data of the specific memory device 300 satisfies the conditions set by an administrator of the server 100, the condition deciding unit 152 decides the recommended operation mode as described above. In the case where the recommended operation mode is decided as described above, the condition deciding unit 152 may notify the host computer 200 provided with the memory device 300 related to the recommended operation mode that the change to the recommended operation mode is possible.

On the other hand, the condition deciding unit 152 may set a threshold value together with the recommended operation mode based on the information stored in the host access diagnostic database 101 by the managing unit 151 and the information including the second access data 321-2 for the second memory device 302. The condition deciding unit 152 may execute the decision of the recommended operation mode as described above based on the threshold value. For example, in the case of changing the operation mode of the first memory device 301, the condition deciding unit 152 may compare the set threshold value with the operation mode pre-set for the first memory device 301 (or the operation mode before change). When the pre-set operation mode exceeds the threshold value, the condition deciding unit 152 may decide the recommended operation mode of the first memory device 301 based on the threshold value and the operation mode.

For example, the read patrol frequency is set by the condition deciding unit 152 based on access data in a predetermined period from the time when the second memory device 302 is put on the market. However, the access frequency may change after that, and it may be decided that the patrol frequency is insufficient at the value set as described above. In such a case, the condition deciding unit 152 may change the operation mode so that the patrol amount (the amount of data for executing the read operation in one patrol) increases.

Alternatively, in the case where the recommended operation mode of the memory device 300 is decided, the condition deciding unit 152 may decide whether the pre-set operation mode needs to be changed. That is, the condition deciding unit 152 compares the operation mode (first operation mode) pre-set for the first memory device 301 with the recommended operation mode decided based on the information including the second access data 321-2 for the second memory device 302. Further, the operation mode of the first memory device 301 may be decided to be the recommended operation mode when the first operation mode is different from the recommended operation mode. Alternatively, the condition deciding unit 152 may decide to change the operation mode of the first memory device 301 to the recommended operation mode when the difference between the recommended operation mode and the operation mode pre-set for the first memory device 301 exceeds the threshold value.

The condition deciding unit 152 may calculate a defective rate of the memory device 300 related to the access data 321 based on the access data 321, and may decide the recommended operation mode based on the defective rate.

The sending unit 153 sends the recommended operation mode decided by the condition deciding unit 152 to the first host computer 201 that controls the first memory device 301. In addition, the sending unit 153 responds to an inquiry from the host computer 200 regarding the necessity of changing the operation mode.

In the present embodiment, although the configuration in which the sending unit 153 sends the recommended operation mode to the host computer 200 is exemplified, the present disclosure is not limited to this configuration. For example, the sending unit 153 may send a parameter for the first memory device 301 corresponding to the recommended operation mode to the host computer 200.

[1-3. Functional Configuration of Host Computer 200]

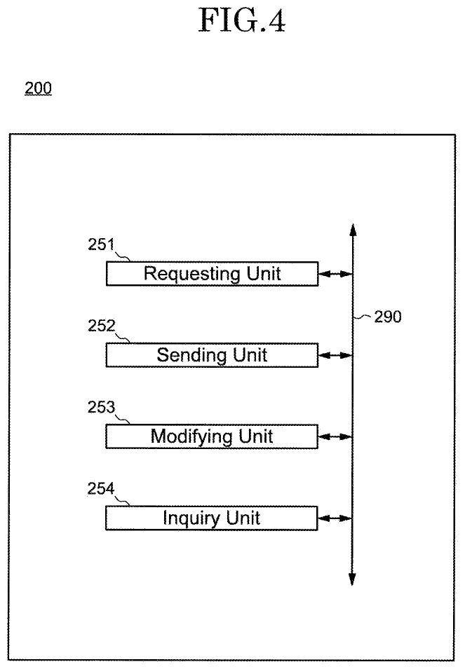

FIG. 4 is a schematic view showing a functional configuration of a host computer according to an embodiment. As shown in FIG. 4, the host computer 200 includes a requesting unit 251, a sending unit 252, a modifying unit 253, and an inquiry unit 254. The requesting unit 251, the sending unit 252, the modifying unit 253, and the inquiry unit 254 are connected to be communicable with each other via a communication bus 290.

The requesting unit 251 requests the access data 321 (including the first access data 321-1 and the second access data 321-2) for the memory device 300 to the memory device 300. The requesting unit 251 requests the first access data 321-1 from the memory device 300 periodically or depending on the operation of the memory device 300. For example, the requesting unit 251 requests the access data 321 at night-time (e.g., am 2:00 to am 4:00) when the operation frequency of the memory device 300 is low, or at a time period when the operation frequency of the memory device 300 is low that is determined by monitoring the operation of the memory device 300. In other words, the requesting unit 251 requests the access data 321 during a time period in which the operation load of the memory device 300 is small.

However, the present disclosure is not limited to this structure. For example, the requesting unit 251 may request the access data 321 each time that the memory controller 310 accesses the non-volatile memory 320 in the memory device 300, may request the access data 321 when the number of accesses reaches a predetermined value, or may request the access data 321 at a predetermined time interval.

The sending unit 252 sends the access data 321 (including the first access data 321-1 and the second access data 321-2) acquired from the memory device 300 to the server 100. The sending unit 252 sends the access data 321 to the server 100 periodically or depending on a communication status between the server 100 and the host computer 200. For example, the sending unit 252 sends the access data 321 to the server 100 at night-time when the communication frequency between the server 100 and the host computer 200 is low, or at a time period when the communication frequency is low that is determined by monitoring the communication status between the server 100 and the host computer 200 in the same manner as described above. In this case, the sending unit 252 may send, the memory-specific information for identifying the memory device 300 or the host-specific information for identifying the host computer 200 to the server 100 together with the access data 321.

The modifying unit 253 changes the operation mode of the memory device 300 based on the recommended operation mode of the memory device 300 received from the server 100. Specifically, based on the recommended operation mode, the modifying unit 253 changes parameters such as a write voltage, a read voltage, and an address of the memory cell for which the write operation and the read operation are executed to parameters corresponding to the recommended operation mode. The recommended operation mode is decided based on the access data 321 (e.g., the second access data 321-2) for other memory devices connected to other computers as described above.

The modifying unit 253 may change a shift table used for the write operation or the read operation. For example, the modifying unit 253 may select a condition suitable for the deteriorated memory cell from the shift table, based on the access data 321, with respect to the memory cell in which the deterioration is estimated to be large.

The modifying unit 253 may specify the address to execute the write operation, avoiding the memory cell where the deterioration is estimated to be large. Alternatively, the modifying unit 253 may specify the address so as to execute the write operation, avoiding memory elements where an operation defect has occurred or memory elements where a defect may occur. The modifying unit 253 may change the frequency of the read patrol operation executed to check the data retention based on the access data 321.

The inquiry unit 254 inquires to the server 100 whether the operation mode of the memory device 300 needs to be changed. The inquiry unit 254 periodically makes inquiries. For example, the inquiry unit 254 may execute the inquiry once a day. Alternatively, the inquiry unit 254 may execute the above inquiry with the host computer 200 activated as a trigger. In the case where there is the recommended operation mode of the memory device 300 in response to the inquiry by the inquiry unit 254, the server 100 sends the recommended operation mode to the inquiry unit 254 in response to the inquiry. The modifying unit 253 changes the operation mode of the memory device 300 based on the recommended operation mode received from the server 100.

[1-4. Operation Mode Recommendation Method]

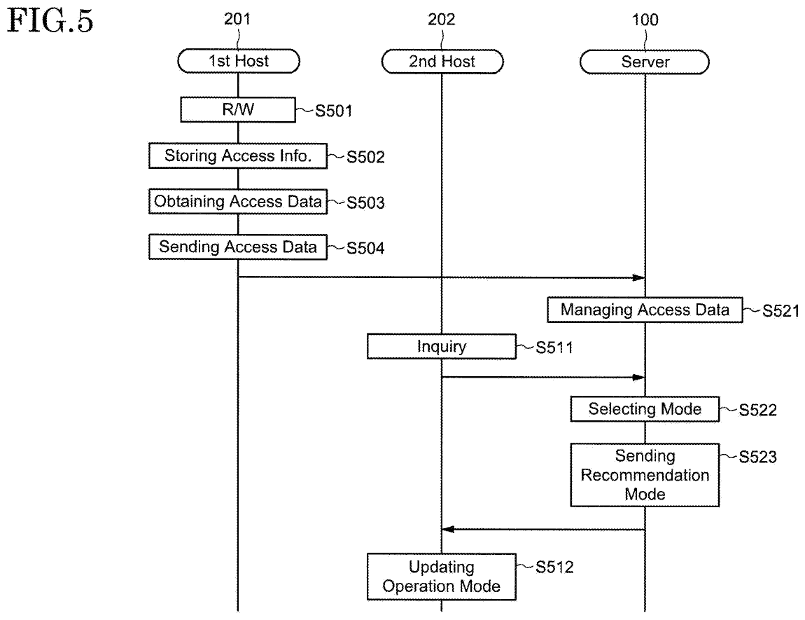

FIG. 5 is a sequence diagram showing an operation mode recommendation method in a memory operation management system according to an embodiment. As shown in FIG. 5, in the present embodiment, the operation mode recommendation method is executed by the first host computer 201 (1st Host), the second host computer 202 (2nd Host), and the server 100. The first host computer 201 includes the first memory device 301. The second host computer 202 includes the second memory device 302.

As shown in FIG. 5, the first host computer 201 executes the write operation or the read operation for the first memory device 301 according to an input from a user (step S501; R/W). The first host computer 201 stores the access data 321 based on the write operation and the read operation in the non-volatile memory 320 (step S502; Storing Access Info). The first host computer 201 repeats the above-described steps S501, S502 until the next step is executed.

The first host computer 201 obtains the access data 321 by requesting the access data 321 from the first memory device 301 (step S503; Obtaining Access Data). For example, a step S503 may be executed at night-time when the operation frequency of the first memory device 301 is low. According to this operation, the first host computer 201 collectively acquires the access data 321 accumulated from the time when previous access data 321 is acquired to the present time. Then, the first host computer 201 sends the access data 321 to the server 100 (step S504; Sending Access Data).

In FIG. 5, although a configuration in which only the first host computer 201 executes the steps S501 to S504 is exemplified, the steps S501 to S504 are executed also in the second host computer 202. That is, the second host computer 202 sends the access data 321 to the server 100 as well as the first host computer 201.

The server 100 stores and manages the access data 321 received from the first host computer 201 (step S521; Managing Access Data). For example, in the case where the first memory device 301 provided in the first host computer 201 and the second memory device provided in the second host computer 202 are the same type of memory device, these memory devices are managed together without any distinction. By executing the steps S501 to S504 and S521 described above for a plurality of host computers, the server 100 stores and manages the access data 321 received from the plurality of host computers.

Next, the second host computer 202 inquires to the server 100 for the presence or absence of the recommended operation mode of the second memory device 302 provided in the second host computer 202 (step S511; Inquiry). In response to this inquiry, the server 100 checks whether there is the recommended operation mode of the second memory device 302 based on the access data 321 managed by the server 100. If there is the recommended operation mode, the server 100 selects an operation mode suitable for the second memory device 302 from the plurality of operation modes managed by the server 100 (step S522; Selecting Mode). Then, the server 100 sends the operation mode selected in the step S522 as the “recommended operation mode” to the second host computer 202 (step S523; Sending Recommendation Mode).

Upon receiving the recommended operation mode from the server 100, the second host computer 202 updates the operation mode of the second memory device 302 according to the recommended operation mode (step S512; Updating Operation Mode). The operation mode of the second memory device 302 is updated by executing the above steps by the first host computer 201, the second host computer 202, and the server 100.

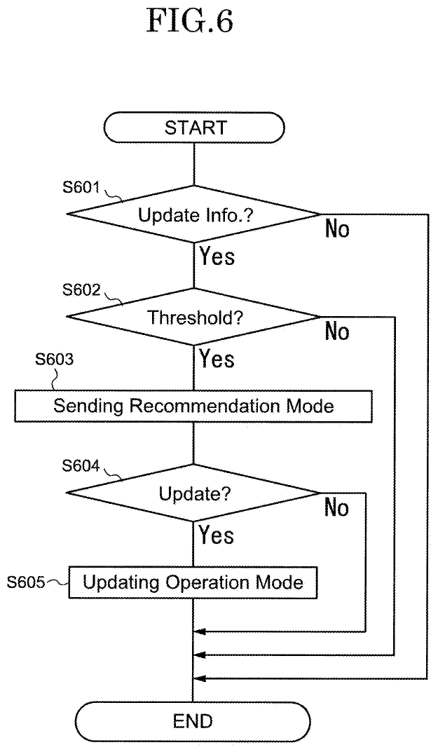

FIG. 6 is a flowchart showing an operation mode recommendation method in a memory operation management system according to an embodiment. The flowchart shown in FIG. 6 shows a detailed operation from when the server 100 receives an inquiry from the second host computer 202 in FIG. 5 (step S511) until when the operation mode is updated in the second host computer 202 (step S512).

As shown in FIG. 6, in response to the inquiry of the step S511 of FIG. 5, the server 100 determines whether there is an updatable operation mode (Step S601; Update Info.?). For example, in the step S511 of FIG. 5, the second host computer 202 sends information indicating the date and time when the previous update was executed for the second memory device 302 or information for identifying the operation mode of the current second memory device 302 to the server 100. The server 100 determines whether there is an updatable operation mode of the present operation mode of the second memory device 302 based on the information.

If it is determined in step S601 that there are no operation modes that can be updated (“No” in S601), the operation shown in FIG. 6 ends. In this case, the operation of the steps S522, S523, and S512 in FIG. 5 is omitted. On the other hand, if it is determined in step S601 that there is an updatable operation mode (“Yes” in S601), the process proceeds to the next step S602.

In step S602, the server 100 determines whether there is the need or not to update the operation mode by comparing the current operation mode of the second memory device 302 set in the second host computer 202 with the updatable operation mode confirmed in step S601.

Specifically, the server 100 determines whether the difference between the present operation mode and the updatable operation mode exceeds the threshold. For example, if the difference is other than zero, that is, if the current operation mode is different from the updatable operation mode, the server 100 may determine whether there is the need or not to update the operation mode. Alternatively, a certain numerical range is defined based on the threshold value, and if the difference is within the numerical range, the operation mode may not be updated, and if the difference exceeds the numerical range, the operation mode may be updated. The threshold value may be set by the administrator of the server 100 or may be dynamically determined by the condition deciding unit 152 based on the access data 321 received from the plurality of host computers.

If it is determined in step S602 that there is no need to update the operation mode (“No” in S602), the operation shown in FIG. 6 ends. In this case, the operation of the steps S522, S523, and S512 in FIG. 5 is omitted. On the other hand, if it is determined in step S602 that there is the need to update the operation mode (“Yes” in S602), the process proceeds to step S603. Since the step S603 is the same as the step S523 of FIG. 5, detailed descriptions thereof are omitted.

In step S604 (Update?) following the step S603, the second host computer 202 determines whether the operation mode of the second memory device 302 should be updated to the recommended operation mode sent from the server 100 to the second host computer 202. Specifically, the second host computer 202 determines the identity between the current operation mode and the recommended operation mode. The second host computer 202 determines that the operation mode should be updated when the current operation mode is different from the recommended operation mode and determines that the update of the operation mode is not required when both operation modes are identical. Alternatively, in the case where the threshold value is set, the second host computer 202 determines that the operation mode should be updated when the difference between the current operation mode and the recommended operation mode exceeds the threshold value, and determines that the update of the operation mode is not required when the difference does not exceed the threshold value.

If it is determined in step S604 that there is no need to update the operation mode to the recommended operation mode (“No” in S604), the operation shown in FIG. 6 ends. In this case, the operation of the step S512 in FIG. 5 is omitted. On the other hand, if it is determined in step S604 that there is the need to update the operation mode to the recommended operation mode (“Yes” in S604), the process proceeds to the next step S605. Since the step S605 is the same as the step S512 in FIG. 5, a detailed description will be omitted.

As described above, the memory operation management system according to the present embodiment can execute the operation of the memory device in the operation mode suitable for the memory device. Even if an optimal operation mode of the memory device is not known when the memory device is put on the market, the memory operation management system 10 can subsequently update the operation mode of the memory device to the operation mode that is optimal for the memory device. Furthermore, the memory operation management system 10 can recognize embodiments of operation of the memory device on the market and update it to the operation mode suitable for the memory device according to embodiments of usage of the memory device on the market. In other words, the memory operation management system 10 can propose an operation mode of the memory device according to its usage.

[2. Second Embodiment]

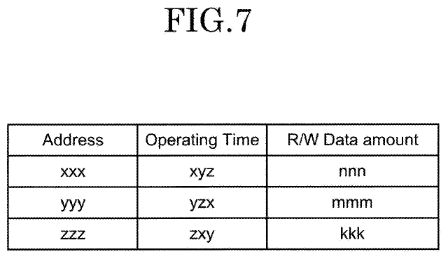

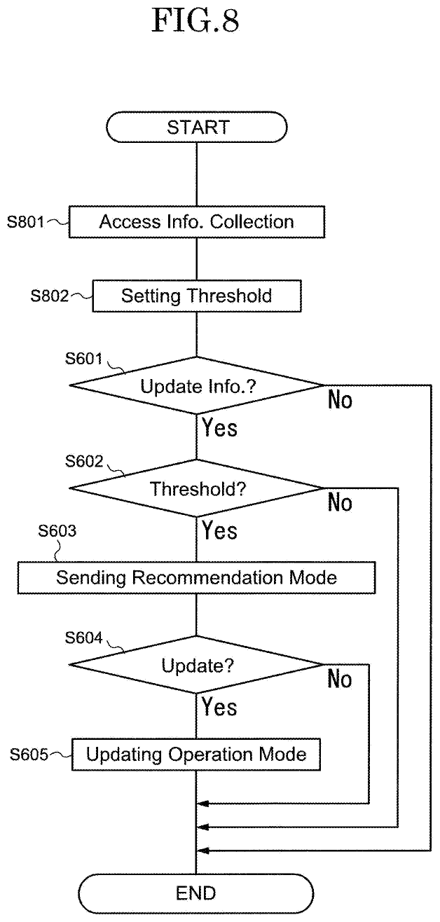

The memory operation managing system 10 according to the second embodiment will be described with reference to FIG. 7 and FIG. 8. The memory operation management system 10 according to the second embodiment is similar to the memory operation management system 10 according to the first embodiment. In the following description of the second embodiment, a description of the same configuration as that of the first embodiment is omitted, and points mainly different from the first embodiment will be described.

[2-1. Operation Mode Recommendation Method]

In the present embodiment, a configuration in which the patrol frequency is changed by changing the operation mode is exemplified. Since the usage of the memory device 300 cannot be predicted at the stage when the memory device 300 is shipped and put on the market, the patrol frequency is often set according to the worst case. On the other hand, in actual usage in the market, the patrol frequency may be insufficient or excessive in this setting. In such a case, the patrol frequency is updated based on the access data 321 as follows.

FIG. 7 is a diagram showing an example of a host access diagnostic database according to an embodiment. When the patrol frequency is adjusted, it is necessary to know how long the memory cells are left unattended to predict the occurrence of data retention. Therefore, for example, as shown in FIG. 7, the access data 321 may include the address (Address) of the memory cell, time-related information (Operating Time) when the write operation or the read operation is executed, and information on the data amount of the memory cell in which the process is executed by the write operation or the read operation (amount of write data or amount of read data (R/W Data amount)). The time-related information may be, for example, information related to the time at which the write operation or the read operation is executed, or information related to the time from a reference time to the time at which the write operation or the read operation is executed. For example, the reference time may be a time when the last write operation or read operation is executed for a memory cell at a certain address. The time-related information and data amount information is sent by the sending unit 252 of the host computer 200 to the server 100. Then, the condition deciding unit 152 of the server 100 determines the recommended operation mode of the memory device 300 (for example, the first memory device 301) based on the time-related information and the information on the data amount. For example, the recommended operation is determined based on the set patrol amount and the address and date and time of the memory cell in which the patrol read was executed.

These information may be managed in association with the memory-specific information (Memory ID). In this case, the condition deciding unit 152 determines the recommended operation mode of the memory device 300 based on the time-related information and the information on the data amount of the memory cell. However, in the case where the server 100 is provided for each type of the host computer 200 or the memory device 300, the memory-specific information may not be included in the access data 321.

FIG. 8 is a flowchart showing an operation mode recommendation method in a memory operation management system according to an embodiment. Although the flowchart of FIG. 8 is similar to the flowchart of FIG. 6, the access data 321 is collected in step S801 (Access Info. Collection) before the determination of whether there is an updatable operation mode in step S601, and then in step S802 (Setting Threshold), a threshold value to determine whether there is the need to update the patrol frequency is set based on the collected access data 321. Since the other flow of FIG. 8 is the same as the flow of FIG. 6, the description thereof is omitted.

Specifically, when it is determined that the access frequency to the predetermined memory cell is less than the threshold value based on the time-related information and the information on the amount of data in the memory cell, there is a high possibility that the time in which the memory cell is left unattended is long, so that data retention may occur. Therefore, in such a case, the operation mode is changed so that the patrol frequency is increased or the patrol amount is increased. Contrary to the above, when it is determined that the access frequency to the predetermined memory cell is equal to or higher than the threshold value, there is a high possibility that the time in which the memory cell is left unattended is short, so there is a low possibility that the data retention will occur. Therefore, the operation mode is changed so that the patrol frequency is lower or the patrol amount is reduced.

As described above, according to the memory operation management system 10 according to the present embodiment, the same effects as those of the memory operation management system 10 in the first embodiment can be obtained.

### 3. Third Embodiment

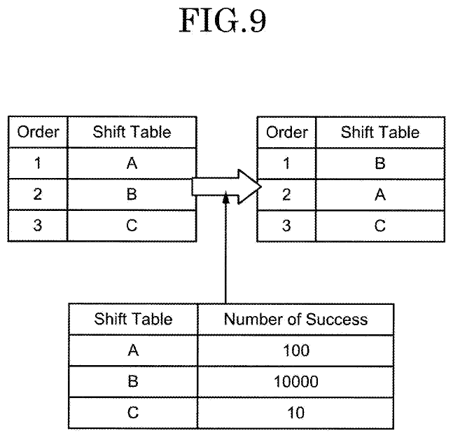

The memory operation managing system 10 according to the third embodiment will be described with reference to FIG. 9. The memory operation management system 10 according to the third embodiment is similar to the memory operation management system 10 according to the first embodiment and the second embodiment. In the following description of the third embodiment, descriptions of the same configurations as those of the first embodiment and the second embodiment are omitted, and points mainly different from those of the first embodiment and the second embodiment will be described.

[3-1. Operation Mode Recommendation Method]

In the present embodiment, a configuration in which the arrangement order of the conditions in the shift table is changed by changing the operation mode is exemplified. Similar to the patrol frequency, since the usage of the memory device 300 cannot be predicted at the stage when the memory device 300 is shipped and put on the market, the configuration of the shift table is not optimized for the usage of the memory device 300 in the market in many cases. Therefore, as described below, the configuration of the shift table (e.g., the order of the conditions in the shift table) is changed based on the access data 321.

FIG. 9 is a diagram showing a specific example of an operation mode recommendation method according to an embodiment. In the shift table of FIG. 9, a plurality of read conditions (conditions “A” to “C” in the items of “Shift Table”) is set. In the shift table, the condition “A” is set to the first, the condition “B” is set to the second, and the condition “C” is set to the third. That is, at first, the read operation is executed under the condition “A.” The read operation is executed under the condition “B” when the read operation cannot be executed under the condition “A.” The read operation is executed under the condition “C” when the read operation cannot be executed under the condition “B.”

For example, when the memory device 300 is used in the market, it is assumed that the number of successes of the read operation according to the condition “A” is 100, the number of successes of the read operation according to the condition “B” is 10,000, and the number of successes of the read operation according to the condition “C” is 10. In this case, in the usage of the memory device 300 in the market, the condition “B” is more suitable than the condition “A” for the memory device 300. If such a trend is found, the number of successes per condition is managed by the host access diagnostic database 101 as information about the shift table of the access data 321. Then, the condition deciding unit 152 changes the arrangement order of the conditions in the shift table based on the access data 321. More specifically, the condition deciding unit 152 updates the shift table so that the condition “B” is the first, the condition “A” is the second, and the condition “C” is the third according to the number of successes of the read operation.

In other words, the information on the number of times that the condition “A” (first read condition) and the condition “B” (second read condition) included in the shift table are executed, respectively, is sent to the server 100 by the sending unit 252 of the host computer 200. The condition deciding unit 152 of the server 100 includes the shift table in which the condition “A” (first reading condition) and the condition “B” (second reading condition) are defined, and changes the order of the condition “A” and the condition “B” in the shift table based on the number of times the condition “A” is executed and the number of times the condition “B” is executed.

As described above, according to the memory operation managing system 10 according to the present embodiment, the read operation is executed in order from the condition where the read operation is likely to succeed when the user uses the memory device 300 by the update of the shift table. Therefore, it is possible to shorten the time required for the read operation. Furthermore, since the frequency of executing the unnecessary read operation is reduced, it is possible to suppress the generation of a defect such as a read disturb. As a result, it is possible to improve the reliability of the memory cell.

In the present embodiment, although the configuration in which the order of conditions in the shift table is changed based on the access data 321 is exemplified, the present disclosure is not limited to this configuration. For example, as a result of the use of the memory device 300 in the market, a condition which is not used at all or a condition in which the number of times of use is equal to or less than the lower limit among the conditions included in the shift table may be deleted from the shift table in a predetermined period.

### 4. Fourth Embodiment

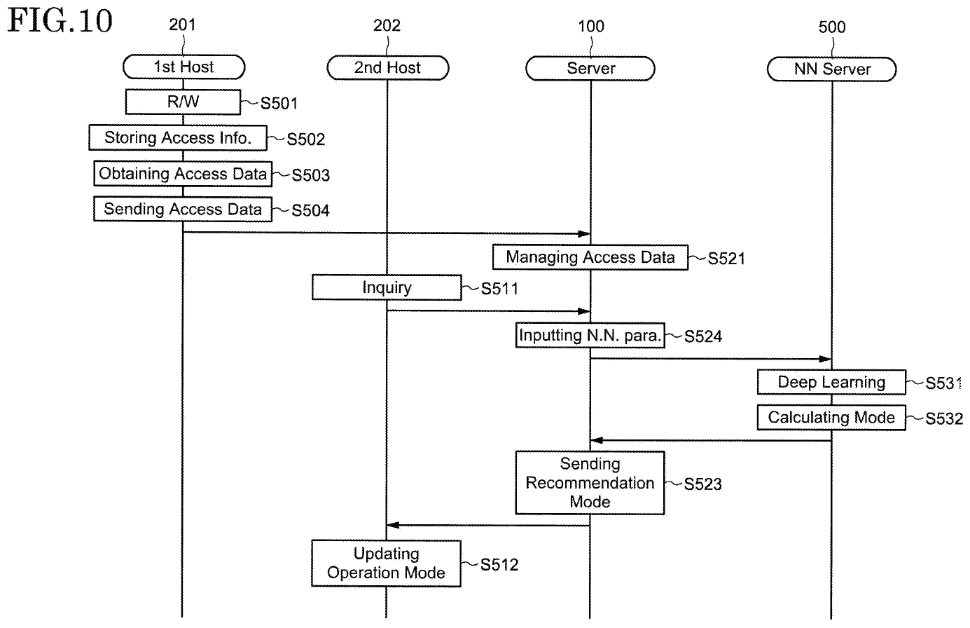

The memory operation managing system 10 according to the fourth embodiment will be described with reference to FIG. 10. The memory operation management system 10 according to the fourth embodiment is similar to the memory operation management system 10 according to the first embodiment. In the following description of the fourth embodiment, a description of the same configuration as that of the first embodiment is omitted, and points mainly different from the first embodiment will be described.

[4-1. Operation Mode Recommendation Method]

In the present embodiment, a configuration in which the recommended operation mode is derived by machine learning based on the access data 321 acquired and stored by the server 100 from the host computer 200 will be described.

FIG. 10 is a sequence diagram showing an operation mode recommendation operation in a memory operation management system according to an embodiment of the present invention. Although the sequence of FIG. 10 is similar to the sequence of FIG. 5, it is different from the sequence of FIG. 5 in that an NN server 500 that provides a neural network is provided separately from the server 100.

As shown in FIG. 10, the NN server 500 executes machine learning (for example, deep learning) based on the access data 321 received from the server 100. The NN server 500 provides a multi-layered neural network and executes machine learning using a model in which a plurality of neutral networks is multi-layered. For example, the NN server 500 accepts a parameter based on the access data 321 managed by the server 100 as an input value and outputs an operation mode based on the input parameter as a recommended operation mode.

As shown in FIG. 10, the server 100 inputs the parameter for the neural network into the NN server 500 in response to the inquiry (step S511) from the host computer 200 (step S524; Inputting N.N. para.). For example, the parameter input includes the type of memory device 300 and the access data 321. the NN server 500 calculates (step S532; Calculating Mode) an operation mode suitable for the memory device 300 by deep learning (step S531; Deep Learning) based on the input. The NN server 500 outputs the operation mode calculated in step S532 to the server 100. The server 100 determines the output operation mode as the recommended operation mode and sends the recommended operation mode to the second host computer 202 (step S523).

The determination of the recommended operation mode is executed by the condition deciding unit 152 of the server 100. Therefore, referring to FIG. 1 and FIG. 3, in other words, the condition deciding unit 152 decides the recommended operation mode of the first memory device 301 by machine learning based on the information including the second access data 321-2 for the second memory device 302, for example.

As described above, according to the memory operation control system 10 according to the present embodiment, the recommended operation mode calculated by machine learning can be provided to the host computer 200. As a result, the memory operation administration system 10 can provide a more appropriate operation mode to the user.

Although the present disclosure has been described above with reference to the drawings, the present disclosure is not limited to the embodiments described above and can be modified as appropriate without departing from the spirit of the present disclosure. For example, the addition, deletion, or design change of components as appropriate by those skilled in the art based on a memory operation management system of the present embodiment are also included in the scope of the present disclosure as long as they are provided with the gist of the present disclosure. Furthermore, each of the embodiments described above as an embodiment of the present disclosure can be appropriately combined and implemented as long as no contradiction is caused.

Further, it is understood that, even if the effect is different from those provided by each of the above-described embodiments, the effect obvious from the description in the specification or easily predicted by persons ordinarily skilled in the art is apparently derived from the present disclosure.

What is claimed is:

1. A server comprising:
a managing unit configured to manage a first access data with respect to a first memory device and a second access data with respect to a second memory device;
a condition deciding unit configured to decide a recommended operation mode of the first memory device based on information including the second access data; and
a sending unit configured to send the recommended operation mode decided by the condition deciding unit to an apparatus configured to control the first memory device.

2. The server according to claim 1, wherein
the information includes both the first access data and the second access data.

3. The server according to claim 1, wherein
the managing unit is configured to manage a plurality of candidate operation modes, and
the condition deciding unit is configured to decide an operation mode of the first memory device by selecting the recommended operation mode among the plurality of candidate operation modes based on the information.

4. The server according to claim 1, wherein
the condition deciding unit is configured to
set a threshold value based on the information, and
decide the recommended operation mode of the first memory device based on a predetermined operation mode of the first memory device and the threshold value.

5. The server according to claim 1, wherein
the condition deciding unit is configured to
compare a predetermined first operation mode of the first memory device with the recommended operation mode decided based on the information, and
decide the recommended operation mode as an operation mode of the first memory device in the case where the first operation mode is different from the recommended operation mode.

6. The server according to claim 3, wherein
the condition deciding unit is configured to determine, whether an operation mode of the first memory device needs to be changed, in accordance with an inquiry from a host computer configured to manage the first memory device, and
the sending unit is configured to send the recommended operation mode to the host computer if an operation mode of the first memory device needs to be changed.

7. The server according to claim 1, wherein
the condition deciding unit is configured to decide the recommended operation mode of the first memory device by machine learning based on the information.

8. The server according to claim 1, wherein
the managing unit is configured to
manage a first specific information identifying the first memory device in association with the first access data, and
manage a second specific information identifying the second memory device in association with the second access data.

9. The server according to claim 1, wherein
the second access data includes time information related to a time when a write operation to a second memory device or a read operation from the second memory device is performed and an amount of data included in a write operation to the second memory device or a read operation from the second memory device, and
the condition deciding unit is configured to decide the recommended operation mode of the first memory device based on the amount of data and the time information.

10. The server according to claim 1, wherein
the second access data includes time information related to a time when a read operation in a patrol for a second memory device is performed and an amount of data included in a read operation in a patrol for the second memory device, and
the condition deciding unit is configured to decide the recommended operation mode of the first memory device based on the amount of data and the time information.

11. The server according to claim 1, wherein
the condition deciding unit has a shift table, a first read condition and a second read condition being specified in the shift table, and
the condition deciding unit is configured to change an order of the first read condition and the second read condition in the shift table based on the number of times the first read condition and the number of times executing the second read condition are executed.

12. A computer configured to perform a write request and a read request to a memory device, and able to communicate with a server, the computer comprising:
a requesting unit configured to request a first access data to the memory device, the first access data corresponding to the memory device;
a sending unit configured to send the first access data obtained from the memory device to the server; and
a modifying unit configured to modify an operation mode of the memory device based on a recommended operation mode of the memory device, the recommended operation mode being received from the server,
wherein the recommended operation mode is decided based on a second access data with respect to the other memory device connected to the other computer.

13. The computer according to claim 12, further comprising an inquiring unit configured to inquire, whether an operation mode of the memory device needs to be changed, to the server,
wherein the modifying unit is configured to modify an operation mode of the memory device based on the recommended operation mode of the memory device, the recommended operation mode being received from the server in response to an inquiry from the inquiring unit.

14. The computer according to claim 12, wherein the sending unit is configured to send a memory specific information identifying the memory device to the server with the first access data.

15. The computer according to claim 14, wherein the sending unit is configured to send a host specific information identifying itself to the server with the first access data and the memory specific information.

16. The computer according to claim 12, wherein the sending unit is configured to send an amount of data included in a write operation to the memory device or a read operation from the memory device, and time information related to a time when the write operation to the memory device or the read operation from the memory device is performed.

17. The computer according to claim 12, wherein the sending unit is configured to send information related to each of the number of times each of a first read condition and a second read condition are executed.
